(19) United States
(12) Patent Application Publication
(10) Pub. No.: US 2014/0011661 A1
(43) Pub. Date: Jan. 9, 2014

(54) METHOD OF MAKING HIGH TOUGHNESS HIGH STRENGTH ZIRCONIA BODIES

(71) Applicant: Vladimir Krstic, Kingston (CA)

(72) Inventor: Vladimir Krstic, Kingston (CA)

(21) Appl. No.: 13/542,995

(22) Filed: Jul. 6, 2012

(51) Int. Cl. C04B 35/48; C04B 35/622

(52) U.S. Cl. 501/134

(57) ABSTRACT

A process for the production of high-density zirconia-based ceramics having high fracture toughness and strength suitable for use as nonconductive weld/guide pins, engine components and wear resistant parts. The process consists of mixing zirconia (with formula ZrO₂) yttria (Y₂O₃) and ceria (CeO₂) in proper proportions to produce partially stabilized zirconia (PSZ) and then doping the PSZ with chromium oxide (Cr₂O₃) to enhance the mechanical strength of the resultant body. The resultant sintered body has fracture toughness in excess of 15 MPa.m^{1/2}, Vicker's Hardness in excess of 8.5 GPa and flexural strength of 1150 MPa.

### FIELD OF INVENTION

The invention relates to doped partially stabilized zirconia ceramics that exhibit high strength, high fracture toughness and excellent resistance to wear, and a method of producing the same. More particularly, the invention relates to the simultaneous addition of yttria (Y₂O₃), ceria (CeO₂) and chromia (Cr₂O₃) to partially stabilized zirconia (ZrO₂) in order to create a microstructure possessing high fracture toughness and strength.

### DESCRIPTION OF THE PRIOR ART

It is well known that zirconia ceramics exist in three different structural forms: cubic form, tetragonal form and monoclinic form, depending on the temperature. It is also known that the addition of stabilizing agents such as yttria (Y₂O₃) and ceria (CeO₂) to zirconia serves to stabilize the tetragonal phase to room temperature and impart desirable mechanical properties. Although it is accepted that both yttria and ceria are useful as stabilizing agents, their role is quite different. For example, the addition of CeO₂ to zirconia polycrystals results in a very high fracture toughness but low fracture strength and hardness as described in Journal of Materials Science, Vol. 20, 1985, pp 1178-1184. To compensate the disadvantage of lower strength and hardness in ceria-doped partially stabilized zirconia, alumina (Al₂O₃) ceramics were added to zirconia as described in Advances in ceramics, 24, science and Technology of zirconia III, The American Ceramic Society, Westerville, Ohio, 1988, pp 721-728. In this work, it has been shown that the strength reached values of up to 900 MPa but the fracture toughness dropped from 20 MPa to 5.5 MPa with increasing alumina content. To further improve the fracture strength, the ceria stabilized zirconia was doped with TiO₂ which is known to dissolve in tetragonal zirconia and acts as a stabilizing agent in a similar manner to Y₂O₃ and CeO₂, as described in Ceramics International 24, 1998, pp 497-506. Similarly, small amounts of tantalum oxide (Ta₂O₅) dissolved in yttria stabilized zirconia was found to increase both fracture toughness and bending strength as described in U.S. Pat. No. 4,886,768. Yttria was most frequently used to stabilize zirconia and also to impart higher strength to the resultant body. To enhance the strength and thermal stability, a zirconia ceramic composition consisting essentially of zirconia containing yttria, ceria and alumina has been proposed in Japanese Patent No. 61-77665 and a zirconia ceramic composition consisting essentially of yttria, magnesia (MgO) and alumina has been proposed in U.S. Pat. No. 4,820,667. The U.S. Pat. No. 4,820,667 also states that the strength of partially stabilized zirconia ceramics is greatly influenced by the ratio of oxides in the mixture and if the mixture ratio is outside of the predetermined range, the bending strength of the partially stabilized zirconia ceramics may not be increased. For example, the highest bending strength was achieved in samples containing 3 mol % yttria, 0 mol % ceria and alumina/magnesia ratio of 90/10. However, no data on the effect of the composition on fracture toughness of the sintered body was reported in the former publication. It has been generally accepted that the zirconia ceramic compositions containing yttria as a stabilizing agent are not useful to enhance fracture toughness, whereas the zirconia ceramic compositions containing ceria as a stabilizing agent are not useful to enhance the strength. It is therefore desirable to provide a zirconia ceramic and a process for producing the same, that has a bending strength equal or higher than that of zirconia ceramic stabilized with yttria and fracture toughness at the level of equal or higher than that of zirconia stabilized with ceria.

In the present invention it was found that if yttria, ceria and chromia are added to zirconia in a proper proportion, both high bending strength and high fracture toughness can be achieved in PSZ. It is, therefore, a primary objective of the present invention to provide a partially stabilized zirconia ceramic superior in bending strength and fracture toughness on the basis of determining an optimum concentration of yttria, ceria and chromia (Cr₂O₃).

### SUMMARY OF THE INVENTION

The present invention is directed in overcoming the problems set forth above. Briefly summarized, according to one aspect of the present invention there is provided a process for producing a zirconia ceramic possessing bending strength of over 1150 MPa and fracture toughness of over 15 MPa.m^{1/2}. According to another aspect, the present invention provides zirconia ceramics that contain yttria from about 1 mol. % to about 2.5 mol. %, ceria from about 4 mol. % to about 7 mol. %, and chromia from about 0.01 mol. % to about 0.035 mol. % and that average crystal grain size constituting the ceramics is less than 0.5 μm, and at least 80% of the crystal grains are tetragonal grains The first step of the process of the invention comprises mixing of the stabilizing agents and a dopant in the presence of water soluble binder and dispersants, drying the mix at 110° C. for 6-8 hours and compacting the powder under the pressure of 150 MPa. In order to achieve high green density, the compacting is carried out for a time sufficient to compact the powder to form a green part having a density in the range of about 3.1 g/cm³ to about 3.6 g/cm³. A preferred density is about 3.4 g/cm³. The second step of the process comprises of: sintering the green part by heating the green part from room temperature at the heating ramp in the range of about 1° C./min. to about 2° C./min. to a sintering temperature T₁ in the range of about 1450° C. to about 1580° C.; maintaining the sintering temperature for about 2 hours; cooling the sintered part from the sintering temperature at the cooling ramp in the range of from about 6° C./min to about 10° C./min.

The zirconia ceramic produced by the process of the invention consists essentially of tetragonal phase crystal grain over the specific range of dopant level. The invention overcomes the disadvantages of the prior art by providing a microstructure consisting essentially of tetragonal phase over a certain range of additive level, having the bending strength of over 1150 MPa and fracture toughness of over 15 MPa.m^{1/2}, improved wear resistance and service lifetime, and is useful in applications such as weld/guide pins.

### BRIEF DESCRIPTION OF TH FIGURES

FIG. 1 is an X-ray diffraction curve before fracture (as received samples) for a zirconia ceramic of the invention doped with 6.5 mole percent CeO₂, 1.8 mole percent Y₂O₃, 0.01 mol percent Cr₂O₃ and 91.7% mol ZrO₂

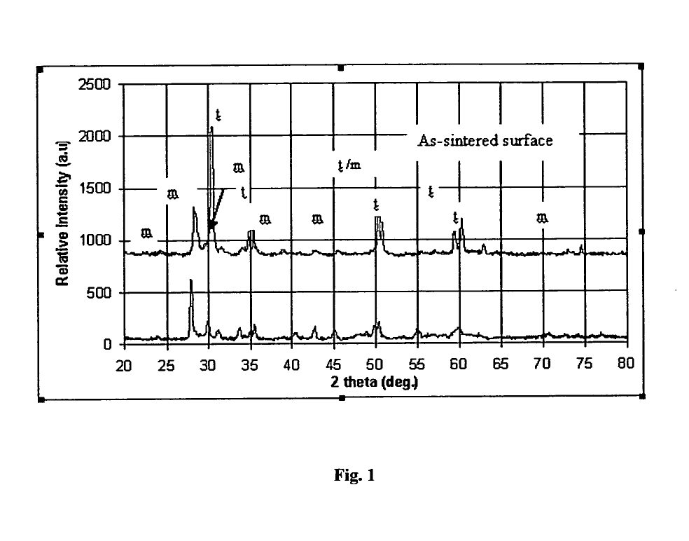

FIG. 2 shows polished and etched surface of a zirconia ceramic doped with CeO₂, Y₂O₃ and Cr₂O₃.

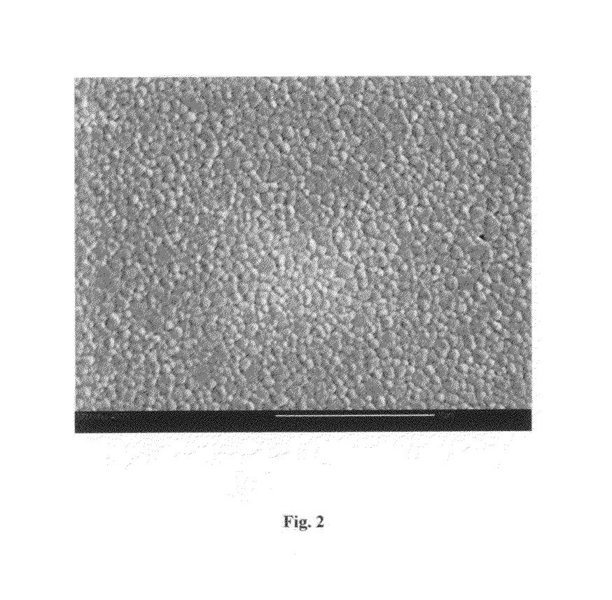

FIG. 3 shows fracture surface of a zirconia ceramic doped with CeO₂, Y₂O₃ and Cr₂O₃

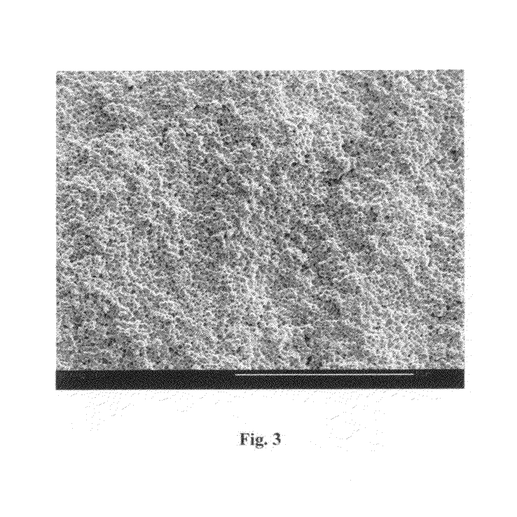

### DETAILED DESCRIPTION OF THE INVENTION

Most additives in ZrO₂ go into solid solution at the sintering temperature and affect the polytype of zirconia retained and hence affect the fracture toughness and bending strength. Such additives include CeO₂, Y₂O₃, MgO and lanthanide oxides. Cr₂O₃ does not go into solid solution with zirconia to a large extent and is an effective grain growth inhibitor. Fracture surface observations revealed that the addition of Cr₂O₃ to zirconia does limit the grain growth resulting in higher hardness and strength. It is also found that the presence of Cr₂O₃ does not have an adverse effect on fracture toughness resulting in zirconia ceramics having both high fracture toughness and high bending strength. By controlling the amount of CeO₂, Y₂O₃ and Cr₂O₃, partially stabilized zirconia ceramics can be made with strength of over 1150 MPa which is similar to yttria-doped tetragonal zirconia particle (Y-TZP) with the added benefit of higher fracture toughness that can be achieved in ceria-doped tetragonal zirconia (Ce-TZP). It has been discovered that a fracture toughness of over 15 MPa.m^{1/2} and bending strength of over 1150 MPa can be achieved in partially stabilized zirconia provided that the level of Y₂O₃ is kept below 2.5 mol. %, the level of CeO₂ is kept below 7 mol. % and the content of Cr₂O₃ is kept below 0.035 mol. % but not less than 0.01 mol. %. It has also been discovered that only with the simultaneous addition of all three additives in proper proportion can both high fracture toughness and high strength be achieved. For the purpose of the present invention, the terms high toughness and high strength refer to values in excess of 15 MPa.m¹² and in excess of 1150 MPa, respectively. If the level of Y₂O₃ is increased above about 2.5 mol. % the strength of the resultant zirconia will increase but the fracture toughness will decrease to less than 6-7 MPa.m^{1/2}. Similarly, if the level of CeO₂ is increased to above 7 mol. % the fracture toughness will increase to above 15 MPa.m^{1/2} but the bending strength will decrease below 800-900 MPa. In the present invention, the enhancement of fracture toughness coincides with optimum addition of cerium oxide and the enhancement of bending strength coincides with optimum addition of yttrium oxide and chromium oxide. High toughness and high strength can sometimes be achieved by adding whiskers or short fibers to a ceramic matrix, as has been demonstrated for SiC whisker-reinforced alumina. However, the problem with this composite is that the presence of whiskers in the matrix inhibits sintering and so far it was impossible to densify the composite to a level above 98% of theoretical density using pressureless sintering.

Conventional powder processing techniques can be used to make high density ceramics. Although the additives (Y₂O₃, CeO₂ and Cr₂O₃) can be used in the form of commercially available powders, co-precipitation or sol-gel processing can be used to synthesize the powders first before using them in that form as raw materials.

When using conventional powder processing techniques, the selected reactants can be mixed by ball milling, vibratory milling, attrition milling, jet milling, high shear mixing or another suitable technique. The powder is then formed by pressing, injection molding, slip casting, extrusion, tape casting, or any other conventional method used for ceramic processing.

The sintering is generally done at temperatures ranging between 1350° C. and 1750° C. in a heating furnace and held at the sintering temperature for several hours, for example 1-4 hours. The sintering atmosphere may be optionally chosen depending on the purpose. For example, air, oxygen, non-oxidizing atmosphere such as a vacuum, nitrogen, argon, or the like or first in the air and then in the non-oxidizing atmosphere can be used.

Furthermore, the matrix consists of a tetragonal crystal structure which contains yttrria and ceria as stabilizers and chromia as a grain growth inhibitor. The obtained zirconia of this invention is of fine grain with equiaxed grains between 0.1 and 3 μm, preferably below 0.5 μm in diameter which provides very high strength without lowering the fracture toughness below 15 MPa.m^{1/2}.

As explained in detail thereabove, this invention provides zirconia ceramics which contains CeO₂ and Y₂O₃ as stabilizers, and Cr₂O₃ as a grain growth inhibitor, having very small average grain size, at the level below about 3 μm and preferably below about 0.5 μm, of the tetragonal crystal phase, which is superior to CeO₂-containing zirconia ceramic in bending strength and markedly superior to Y₂O₃-containing zirconia ceramics in fracture toughness and in bending strength as compared with those containing CeO₂ and Y₂O₃ individually and not in combination. The zirconia ceramics of this invention are useful for applications as weld/guide pins, engine parts, extrusion and drawing dies, ball for boll point pens, mechanical seals, and solid electrolyte materials such as oxygen sensors.

### Examples 1-4

Zirconia powders comprising 1 to 2.5 mol. % Y₂O₃, 3 to 7 mol. % CeO₂, 0.01 to 0.0.035 mol. % Cr₂O₃ and 89.5 mol. % to 90.5 mol. % ZrO₂, were mixed for 6 hours in a plastic jar with methanol as the vehicle and zirconia balls as the milling media. The slurry was dried in a dryer at 75° C. for 12 hours. The powder mixture was dry screened to −40 mesh before uniaxial pressing at 150 MPa, followed by cold isostatic pressing at 250 MPa. The rectangular shape specimens (35×16×8 mm) were sintered in air at temperatures in the range from 1450° C. to 1650° C. for 1 to 4 hours.

The rate of heating was as follows: 0.5° C./min to 500° C., 1° C./min from 500° C. to sintering temperature. Fracture toughness was determined by the indentation method on the polished surfaces and the fracture strength was determined by four-point bending from the fracture of the bend specimens at cross head speed of 0.5 mm/min. Properties of sintered samples containing 6 mol. % ceria and various levels of ytria are given in Table 1.

Detailed scanning microscopy and X-ray diffraction analysis revealed the presence of 13.63 vol. % monoclinic phase with the remaining phase being the tetragonal phase. The results of Table 1 also show that the resultant zirconia body has fine grain structure and the highest bending strength is achieved with material having lowest mean particle size.

### Examples 5-8

A series of tests were performed in which starting powders were prepared from the co-precipitation of the aqueous solution of zirconium oxi-chloride (ZrOCl₂), yttrium nitrate (YNO₃)₃, cerium nitrate and chromium nitrate. The composition of the powder was the same as in examples 1-4. The obtained precipitates were dried and transformed to the oxides by calcination. The as synthesized powder was milled to particle sizes below 1 μm, followed by drying, crushing and sieving through the sieve −40 mesh size. The rectangular shape bars (35×16×8 mm) were isostatically pressed and sintered in air at temperatures in the range from 1450° C. to 1650° C. for 1 to 4 hours. Mechanical properties of the sintered samples as a function of ceria content are presented in Table 2. The level of ytria was kept at the level of 2 mol. %. The highest fracture toughness was obtained in samples having the highest mole percent of ceria additive.

### Examples 9-11

In this set of samples, the initial powder was prepared from the co-precipitation of aqueous solutions of zirconia, yttria, ceria and chromia. The concentrations of ceria was kept at 6 mol. % and yttria at 2 mol. %. The chromia content was varied from 0.2 to 0.9 mol. %. The obtained precipitates were dried, screened, milled, pressed and sintered in the same manner as in examples 1-4. The resultant mechanical property data is presented in Table 3. The results in Table 3 show that as the amount of chromia is increased, the bending strength of the sintered body is increased.

The process and product of this invention are explained in detailed in the proceeding examples which are illustrative only. Those skilled in the art will recognize that there are numerous modifications and variations and that the present invention is not limited to such examples.

TABLE 1

| | Fracture | | Mean | |
|---|---|---|---|---|
| | toughness | Bending | particle | Yttria |
| | K_{IC}, | strength | size | content |
| Sample | MPa · m^{1/2} | MPa | μm | Mol. % |
| No. 1 | 6.6 | 1150 | 0.35 | 1.0 |
| No. 2 | 12.0 | 850 | 0.7 | 2.5 |
| No. 3 | 15.7 | 1100 | 0.50 | 1.5 |
| No. 4 | 16.0 | 900 | 0.7 | 2.0 |

TABLE 2

| | Fracture | | Mean | |
|---|---|---|---|---|
| | toughness | Bending | particle | Ceria |
| | K_{IC}, | strength | size | content |
| Sample | MPa · m^{1/2} | MPa | μm | Mol. % |
| No. 5 | 6.5 | 1180 | 0.30 | 3 |
| No. 6 | 13.0 | 900 | 1.0 | 4 |
| No. 7 | 14.7 | 1100 | 0.35 | 6 |
| No. 8 | 15.0 | 1100 | 0.5 | 7 |

TABLE 3

| | Fracture | | | Mean |
|---|---|---|---|---|
| | toughness | Bending | Chromia | particle |
| | K_{IC}, | strength | content | size |
| Sample | MPa · m^{1/2} | MPa | Mol. % | μm |
| No. 9 | 6.0 | 1220 | 0.01 | 0.2 |
| No. 10 | 12.5 | 1100 | 0.02 | 0.5 |
| No. 11 | 15.9 | 980 | 0.03 | 0.9 |

What is claimed is:

1. A method of making zirconia ceramic composition consisting of ZrO₂ present at about 89.5 to 90.5 mol. %, two minor stabilizing components consisting of Y₂O₃ present at about 1 to 2.5 mol. % and CeO₂ present at about 3 to 7 mol. %, and a grain refining/strengthening agent consisting of Cr₂O₃ present at about 0.01 to 0.035 mol. %.

2. The ceramic of claim 1, wherein the raw material which includes the zirconia matrix, and the three additives which includes yttria, ceria and chromia, are in the form of solid oxide powders.

3. The ceramic of claims 1 and 2, wherein the raw material which includes the zirconia matrix, and the three additives which includes yttria, ceria and chromia, are in the form of soluble compounds which include chlorides, acetates, and nitrates.

4. The ceramic of claims 1, 2 and 3 wherein the matrix has a grain size that is equiaxed and less than 0.5 microns.

5. A method of making zirconia ceramic composition consisting of ZrO₂ present at about 96 to 90.5 mol. %, Y₂O₃ present at about 1 to 2.5 mol. %, and CeO₂ present at about 3 to 7 mol. %.

6. The ceramic of any one of the preceding claims having fracture toughness greater than 15.7 MPa.m^{1/2} and room temperature four-point bend strength greater than 1100 MPa.

7. The ceramic of any one of the preceding claims having fracture toughness greater than 16 MPa.m^{1/2} and room temperature four-point bend strength greater than 900 MPa.
